(19) United States
(12) Patent Application Publication
(10) Pub. No.: US 2005/0183239 A1
(43) Pub. Date: Aug. 25, 2005

(54) Hinge structure, electronic device and cover utilizing the same

(75) Inventor: Sheng-Kao Chen, Hsinchu (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/038,366

(22) Filed: Jan. 21, 2005

(30) Foreign Application Priority Data
Feb. 20, 2004 (TW) 93202431

(51) Int. Cl. E05D 7/10

(52) U.S. Cl. 16/286

(57) ABSTRACT

A hinge structure, an electronic device, and a cover utilizing the same. The hinge structure for supporting a cover comprises an elastic member, a connecting portion, and a pivot. The elastic member comprises two ends. The connecting portion is disposed on an end of the elastic member. The pivot is disposed on the other end of the elastic member and rotatably connected to the cover. A gap is formed between the pivot and the connecting portion. When the cover rotates from a first position to a second position, the cover applies a force on the pivot such that the width of the gap is changed via elasticity of the elastic member.

### BACKGROUND

The invention relates to an electronic device and in particular to an electronic device and a hinge structure thereof.

Multi-function devices combine the capabilities of a copier, printer, fax machine, and/or scanner in one device. These devices offer numerous efficiency advantages including, compact design, fewer purchases, and reduced operating costs.

FIG. 1A is a schematic view of a multi-function device with a conventional hinge structure 110, a cover 120, and a main body 130 thereof. To meet a compact profile requirement, the cover 120 is thin, and a gap x between the cover 120 and the main body 130 is small. As a result, the hinge structure 110 protrudes a relative short distance y from the main body 130. As shown in FIG. 1b, when the conventional hinge structure 110 is utilized, the cover 120 cannot be opened smoothly due to an obstructed area 140 indicated by hatched lines.

Thus, an improved hinge structure enabling smooth opening a cover of a multi-function device with a compact profile is desirable.

### SUMMARY

Thus, an embodiment of the invention provides an electronic device using a hinge structure and a cover thereof that eliminates the above described disadvantages.

Embodiments of the invention provide a hinge structure comprising an elastic member, a connecting portion, and a pivot. The elastic member comprises two ends. The connecting portion is disposed on an end of the elastic member. The pivot is disposed on the other end of the elastic member and rotatably connected to the cover. A gap is formed between the pivot and the connecting portion. When the cover rotates from a first position to a second position, the cover applies a force on the pivot such that the width of the gap is flexibly changed via elasticity of the elastic member.

An electronic device having a cover and the hinge structure is also disclosed.

Thus, the cover of an embodiment of the invention can be opened smoothly.

Additionally, the hinge structure has a simple design, low manufacturing cost and is applicable in any compact electronic device requiring a hinge.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1a is a schematic view of a conventional hinge structure of a multi-function device;

FIG. 1b is a schematic view of a conventional multi-function device in an opened position;

FIG. 2 is a schematic view of a hinge structure of an embodiment of the invention;

FIG. 3a is a schematic view of a multi-function device utilizing the hinge structure according to an embodiment of the invention; and

FIG. 3b is a schematic view of a multi-function device in an opened position according to an embodiment of the invention.

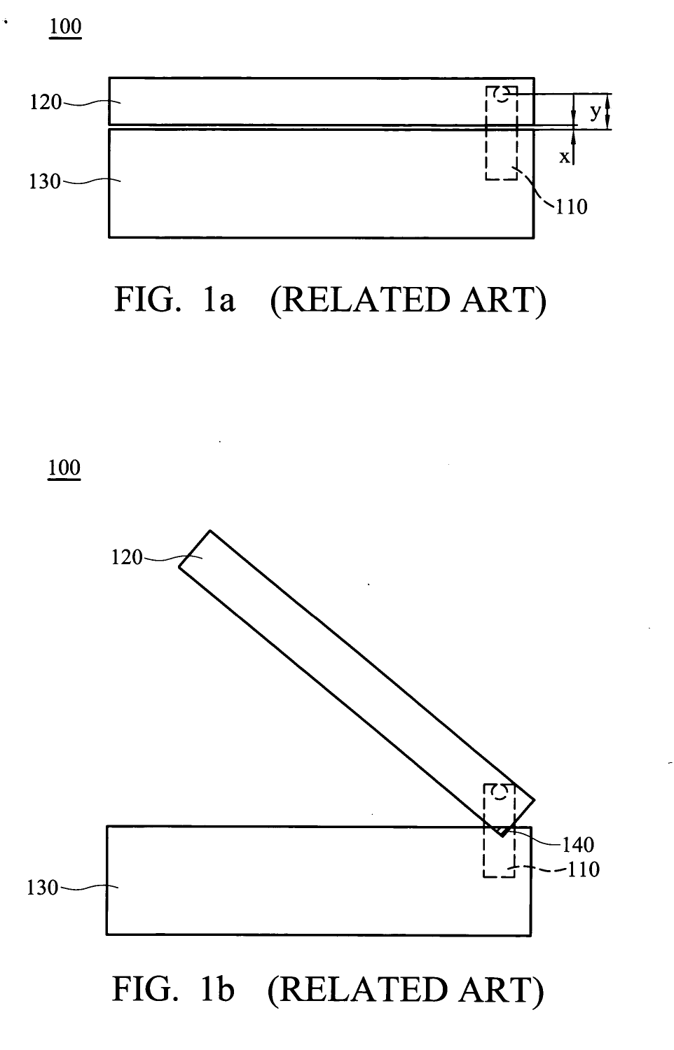

### DETAILED DESCRIPTION

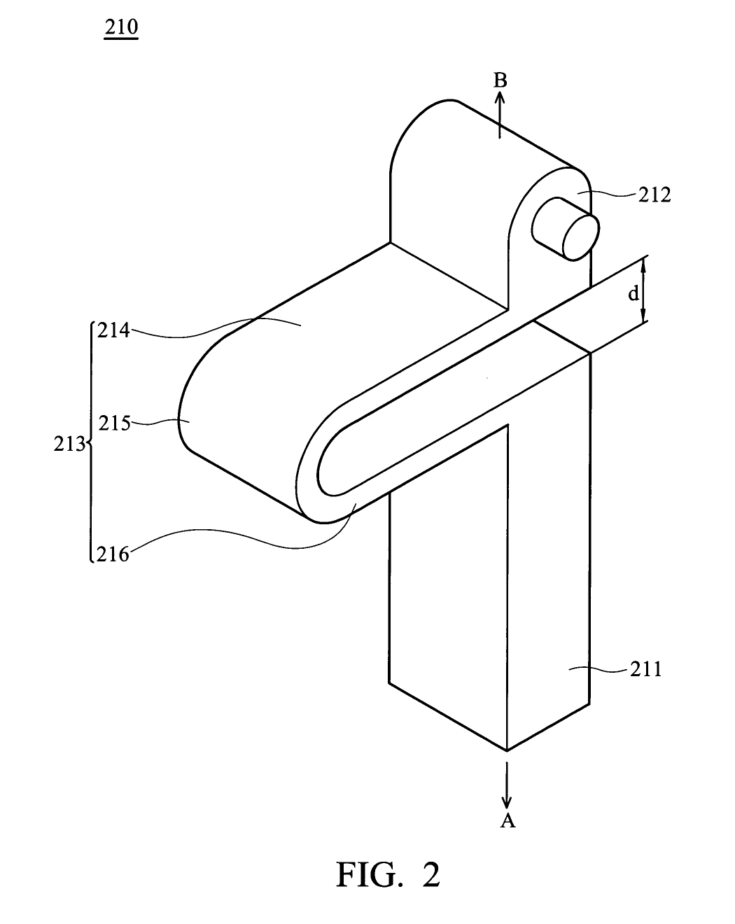

FIG. 2 is a schematic view of a hinge structure 210 of an embodiment of the invention. The hinge structure 210 comprises a connecting portion 210, a pivot 212, and an elastic member 213. The connecting portion 211 connects to a main body of an electronic device such as a multi-function structure. The pivot 212 connects to the cover (not shown). The elastic member 213 is disposed between the pivot 212 and the connecting portion 211 such that a gap d formed therebetween is flexibly changed via elasticity of the elastic member 213.

In this embodiment, the elastic member 213 comprises a first portion 214, a second portion 215, and a third portion 216. The first portion 214 is plate-shaped. The second portion 215 is curved or semi-cylindrical. The third portion 216 is plate-shaped. The second portion 215 connects the first and third portion 214 and 216. The third portion 216 connects to the connecting portion 211, facing the pivot 212 with a gap d therebetween. The gap d varies with deformation of the elastic member 213.

When the first portion 214 of the elastic member 213 sustains a stress A in an opposite direction of stress B on the third portion 216, the gap d between the connecting portion 211 and the pivot 212 is increased by elastic variation of the second portion 215.

Note that the elastic member 213 comprises plastic or other elastic material.

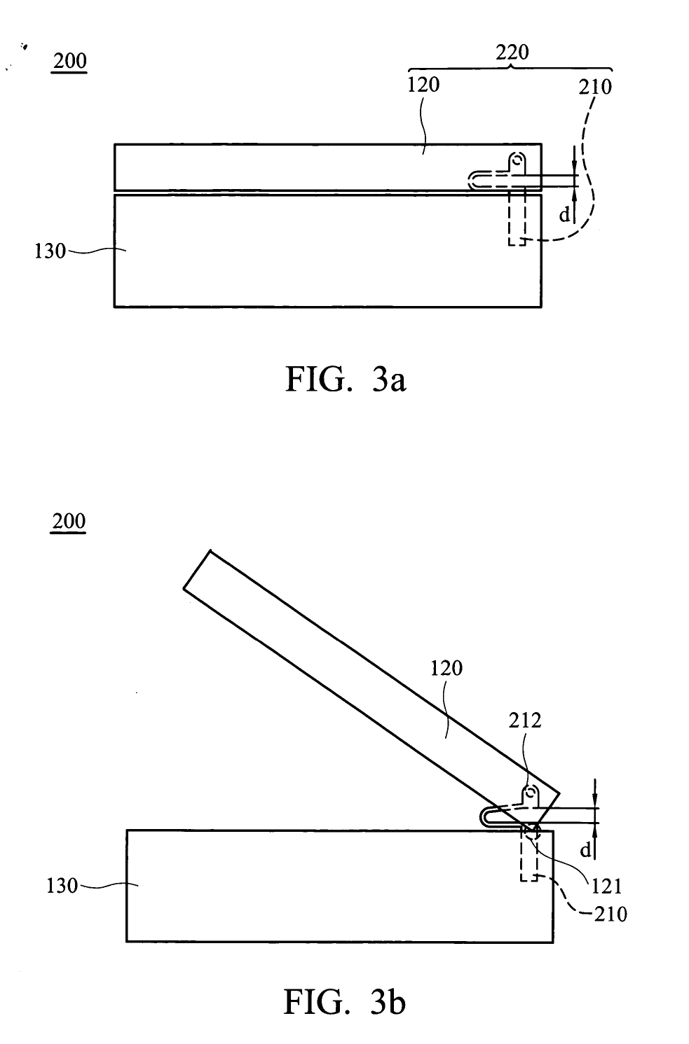

As shown in FIG. 3a, a multi-function device 200 using the hinge structure 210 comprises a main body 130 and a cover 220. The cover 220 comprises a body 120 and the hinge structure 210, connecting the body 120 of the cover 220 and the main body 130 of the multi-function device 200 when the body 120 of the cover 220 is in a closed position (a first position). In FIG. 3b, the body 120 is opened (a second position). In the second position, an end 121 contacts the main body 130, while the cover applies a force on the pivot 212 of the hinge structure 210. The elastic member 213 produces an elastic force to push the pivot 212 upward such that the gap d between the connecting portion 211 and the pivot 212 is increased. Thus, the cover 120 is free to open.

In conclusion, embodiments of the invention provide a modified hinge structure enabling opening of the cover without being obstructed by the main body of a compact multi-function device.

Additionally, the structure is simple, offers reduced manufacturing costs and can be easily applied in various multi-function devices.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A hinge structure for supporting a cover, comprising:
an elastic member comprising two ends,
a connecting portion, disposed on an end of the elastic member; and
a pivot, disposed on the other end of the elastic member, rotatably connected to the cover, wherein a gap is formed between the pivot and the connecting portion; when the cover rotates from a first position to a second position, the cover applies a force on the pivot such that the width of the gap is flexibly changed via elasticity of the elastic member.

2. The hinge structure as claimed in claim 1, wherein the elastic member comprising a first portion, a second portion, and a third portion; wherein the first portion is plate-shaped, the second portion is curved, the third portion is plate-shaped, and the second portion connects the first portion and the third portion.

3. The hinge structure as claimed in claim 2, wherein the first portion connects to the pivot, the third portion connects to the connecting portion; the pivot faces the connecting portion and the gap is formed therebetween.

4. The hinge structure as claimed in claim 1, wherein the elastic member comprises plastic.

5. A cover, comprising:
a body; and
a hinge structure, comprising:
an elastic member comprising two ends,
a connecting portion, disposed on an end of the elastic member; and
a pivot, disposed on the other end of the elastic member, rotatably connected to the body, wherein a gap is formed between the pivot and the connecting portion; when the body rotates from a first position to a second position, the cover applies a force on the pivot such that the width of the gap is flexibly changed via elasticity of the elastic member.

6. The cover as claimed in claim 5, wherein the elastic member comprising a first portion, a second portion, and a third portion; wherein the first portion is plate-shaped, the second portion is curved, the third portion is plate-shaped, and the second portion connects the first portion and the third portion.

7. The cover as claimed in claim 6, wherein the first portion connects to the pivot, the third portion connects to the connecting portion; the pivot faces the connecting portion and the gap is formed therebetween.

8. The cover as claimed in claim 5, wherein the elastic member comprises plastic.

9. An electronic device, comprising:
a main body;
a cover, comprising a body and a hinge structure,
wherein the hinge structure comprises:
an elastic member comprising two ends,
a connecting portion, disposed on an end of the elastic member and fixed on the main body; and
a pivot, disposed on the other end of the elastic member, rotatably connected to the body of the cover, wherein a gap is formed between the pivot and the connecting portion; when the body of the cover rotates from a first position to a second position, the cover applies a force on the pivot such that the width of the gap is flexibly changed via elasticity of the elastic member.

10. The electronic device as claimed in claim 9, wherein the elastic member comprising a first portion, a second portion, and a third portion; wherein the first portion is plate-shaped, the second portion is curved, the third portion is plate-shaped, and the second portion connects the first portion and the third portion.

11. The electronic device as claimed in claim 10, wherein the first portion connects to the pivot, the third portion connects to the connecting portion; the pivot faces the connecting portion and the gap is formed therebetween.

12. The electronic device as claimed in claim 9, wherein the elastic member comprises plastic.
